(19) United States
(12) Patent Application Publication
(10) Pub. No.: US 2016/0348833 A1
(43) Pub. Date: Dec. 1, 2016

(54) Flexible hugger system for cylindrical and odd shaped objects

(71) Applicant: Paul Herrick Peterson, Ellicott City, MD (US)

(72) Inventor: Paul Herrick Peterson, Ellicott City, MD (US)

(21) Appl. No.: 14/545,610

(22) Filed: May 29, 2015

(51) Int. Cl. F16M 13/02; F16B 1/00; F16B 47/00

(52) U.S. Cl. CPC F16M 13/022; F16B 47/00; F16B 1/00; F16B 2001/0035

(57) ABSTRACT

The invention provides for an apparatus to hold and secure cylindrical and odd shaped objects of varying size, comprising a novel bracket configuration and novel elastic cord component and used in conjunction with COTS (Commercial Off The Shelf) components in the form of conventional set screws and fasteners. In this manner, the inventive concept provides for means for securing cylindrical and odd shaped objects in household, commercial receptacles, cabinets, including refrigerators, storage units, and additionally, for securing objects in marine and recreational vehicles, and sports bikes, sports marine crafts, and other such sports vehicles.

### STATEMENT REGARDING FEDERALLY SPONSORED RESEARCH OR DEVELOPMENT

This Application claims priority by U.S. Provisional Application No. 61/997,468 with a Filing Date of Jun. 2, 2014.

### REFERENCE TO SEQUENCE LISTING IN A TABLE, OR A COMPUTER PROGRAM LISTING COMPACT DISK APPENDIX

Not applicable.

### BACKGROUND OF THE INVENTION

The present invention generally relates to an apparatus to hold cylindrical and odd shaped objects that are in daily use in both at rest, or static and in motion.

Existing prior art examples include U.S. Pat. No. 1,014,004—Irwin, U.S. Pat. No. 3,746,179—Paumgardhen, U.S. Pat. No. 6,334,562—Ament et al, U.S. Pat. No. 8,006,846—Robertson, and U.S. Pat. No. 8,573,002—Ledoux et al, all have limitations in terms of versatility, interchangeability, an in adaptability for a variety of uses.

U.S. Pat. No. 1,014,004—Irwin, specifically discloses a single bottle holder with a flexible strap with hook attachment means only.

U.S. Pat. No. 1,991,306—Woolsey, discloses a generic article holder.

U.S. Pat. No. 3,746,179—Paumgardhen, specifically provides for supporting in a flexible vertical band a plurality of cylindrical objects, such as wine bottles.

U.S. Pat. No. 4,444,358—Spohn et al, specifically discloses a fluid reservoir container bracket and holder for an automobile solvent bottle.

U.S. Pat. No. 5,370,288—Field, discloses an adjustable loop-type holder.

U.S. Pat. No. 5,950,844—Taylor, discloses a support apparatus with an elastic cord feature.

U.S. Pat. No. 6,220,557—Ziayiek et al, discloses a mounting bracket for a specific circular shaped object.

U.S. Pat. No. 6,334,562—Ament et al, specifically discloses a stowage device for a range of different shaped objects contained in a receiving net attached to a flat surface primarily intended for use in motor vehicles.

U.S. Pat. No. 7,429,023—Morrow, discloses a bracket for deck support.

U.S. Pat. No. 8,006,846—Robertson, specifically provides for retaining medical vials in a portable carrying case using elastic cords and with a plurality of spaced divider walls.

U.S. Pat. No. 8,573,002—Ledoux et al, specifically discloses a portable cooler configuration wherein objects, such as bottles, are retained and secured in a vertical configuration by means of reconfigurable dividers separating the objects.

US 2005/0023312—Steinberg, discloses a vehicle cargo restraint and storage device.

There are a number of US Design Patents that have features for supporting bracket configurations and these include, U.S. Pat. No. Des 401,838,—Beauchemin, U.S. Pat. No. D 590,697—Townley, U.S. Pat. No. D 633,781—Wood, U.S. Pat. No. 699,549—Giessmann et al, and U.S. Pat. No. D 715,790—Conomos et al.

The aforementioned prior art devices such as those disclosed above are adequate for the basic purposes as in the instant invention and are uniformly deficient with their capability to provide comprehensive, simple, efficient, and practical means of securing and holding in place cylindrical and odd shaped objects for a variety of applications.

To address the particular limitations in the prior art, the instant invention provides a novel arrangement for providing a flexible, adaptable and versatile means for holding in place and securing cylindrical and odd shaped objects in a variety of applications.

Therefore a comprehensive device was needed to provide a means to overcome the limitations in the existing prior art examples.

### BRIEF SUMMARY OF THE INVENTION

This instant invention provides for the a flexible component storage system in place of fixed rack systems provided by existing component storage systems.

The essence of the instant invention is to meet the following basic requirements:
1. hold and retain in place, bike and sports bottles of varying size and dimensions.
2. hold and retain in place, baby bottles of varying size and dimensions.
3. providing minimal receptacle outline, and minimizing cabinet damage due to simplicity of rack attachments.
4. providing minimalist overall styling without any rattling when objects are placed.
5. comprising water resistant and easy handling facilities for retaining a multiplicity of objects.
6. securing method ensures components are held tight by the retaining cords, elastic bands, cords, stretchable materials, so that attachments stay strong over time.
7. means of securing brackets are compatible with retaining cords, elastic bands, cords of different length.

The essential element common to all the embodiments included in the instant invention is novel feature of a novel right angled bracket with specific openings and slots, and novel elastic cord used in conjunction with other elements using Commercial Off The Shelf (COTS) to form a cost effective and efficient means to accomplish the stated objectives of the instant invention of providing a versatile means of storing and securing a variety of objects.

The various disclosed embodiments of the instant invention have in common the capability of securing and retaining a plurality of objects in a plurality of storage configurations.

### BRIEF DESCRIPTION OF THE DRAWINGS

Various features, aspects, and advantages of the present invention will become apparent with reference to the following FIGS. 1 to 5.

FIG. 1 shows a typical view of the inventive concept with the principal principle component of a novel angled bracket.

FIG. 2 shows the custom made elastic retaining cord.

FIG. 3 shows a typical embodiment of the instant invention for retaining objects, such as plastic bottles stored and secured to a flat surface.

FIG. 4 shows the novel angled bracket using COTS fasteners.

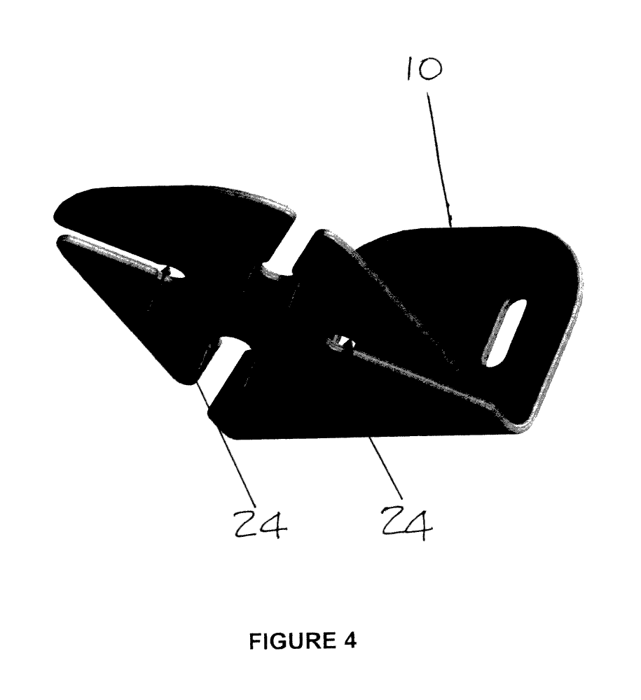

FIG. 5 shows an example of an application of the instant invention.

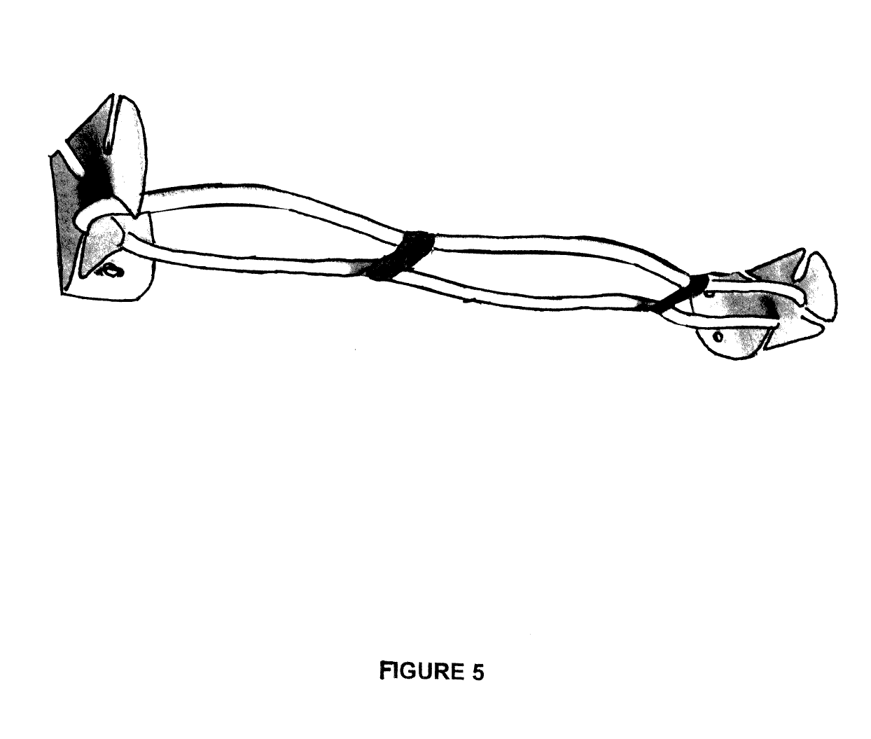

### LIST OF REFERENCE NUMBERS FOR THE ELEMENTS IN THE DRAWINGS

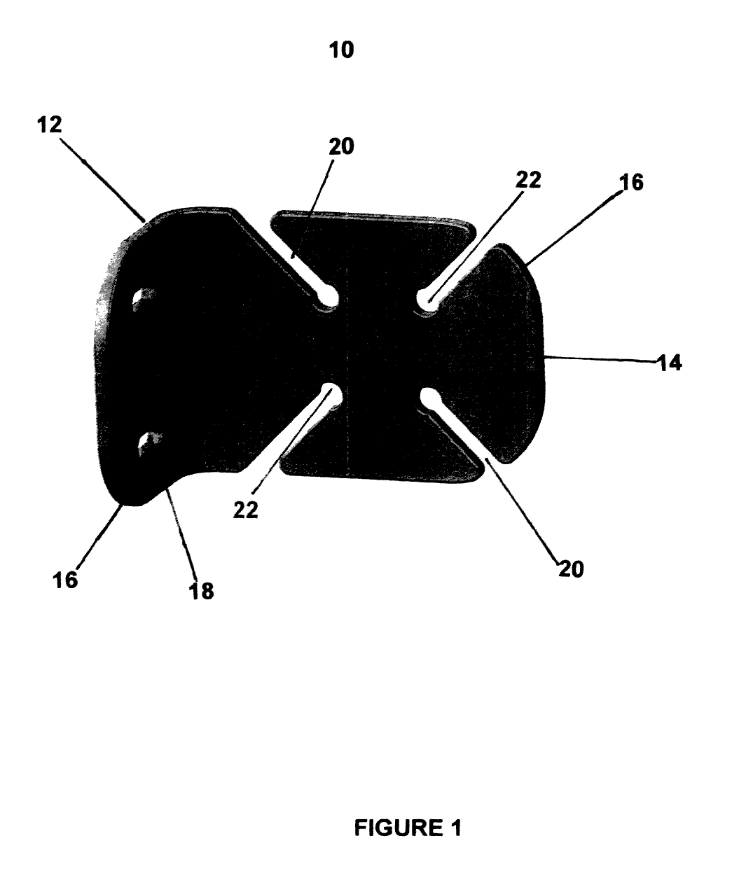

10 in FIG. 1 shows the essential element configuration of the instant invention in the form of a right angled bracket manufactured from plastic, glass reinforced plastic, metal or other load bearing materials.

12 in FIG. 1 shows the shorter face of the item 10.

14 in FIG. 1 shows the longer face of item 10.

16 in FIG. 1 shows circular corners at each end of items 12 and 14.

18 of item 12 in FIG. 1 shows a plurality of elongated slots in one face of the right angled bracket 10 to provide a means for inserting COTS screws and fasteners to secure item 10 to a flat surface.

20 in FIG. 1 shows plurality of angular slots in 14 formed in a diagonal manner at an angle of approximately 45 degrees to a horizontal plane.

The angular slots 20 in FIG. 1 are further configured with circular openings 22 at one end of the angular slots in a manner to facilitate the placement for receiving customized components such as retaining cords, elastic bands, cords, flexible strap and other stretchable materials.

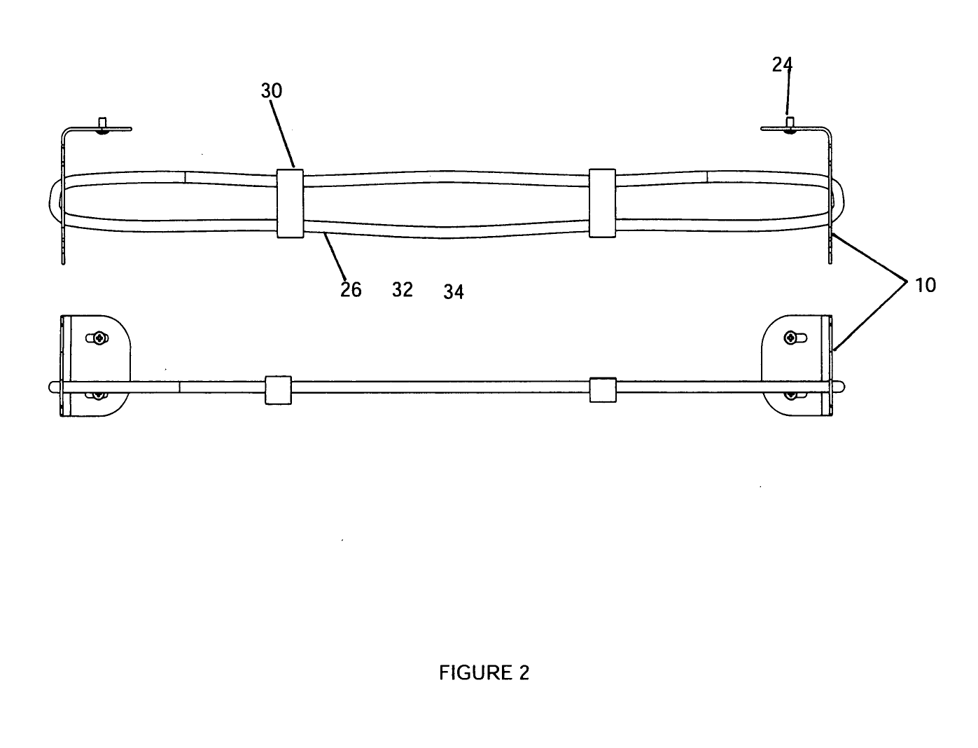

24 in FIG. 2 are items considered in the COTS category used for securing, fastening, and screws and similar fittings used to attach item 10 to a flat surface.

26 in FIG. 2 shows novel arrangement of unique retaining cords, elastic bands, cords, stretchable materials.

The retaining cord, band 26 in FIG. 2 is in the form of two parallel and opposing cords, bands.

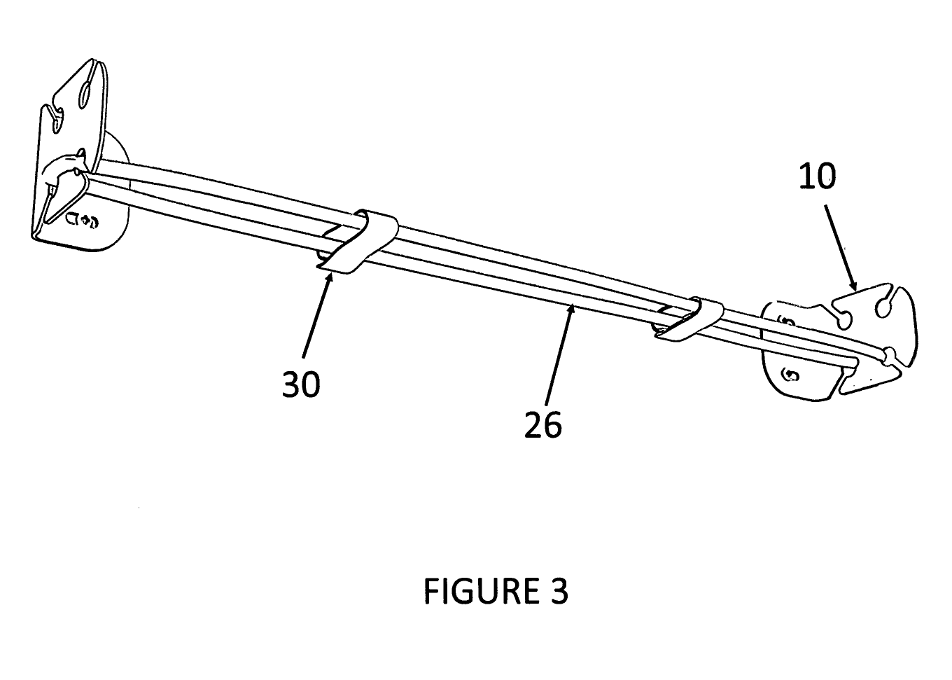

30 in FIG. 3 are cross-bracing ties dividing item 26 retaining cords, bands loops.

The combination of the unique right angled bracket item 10 in combination with the unique elastic cord items 26, 32, 34 in FIG. 2, forms the basis of a novel storage system 28.

### DETAILED DESCRIPTION OF THE INVENTION

The instant invention is novel in that it provides a plurality of configurations for retaining and securing objects in a range of settings, such as refrigerators, enclosed cabinets, and free standing surfaces such as for example, recreation vessel decks, patio decks.

The invention in the multiplicity of embodiments disclosed all comprise the novel right angled item 10, and unique and novel elastic continuous cord, band item 26 which are used with a series of COTS components for a range of inventive concept embodiments.

The unique right angled bracket item 10 is capable of being made from a range of metallic and non-metallic materials including but not limited to ferrous, non-ferrous, plastic, glass reinforced plastic, and fiber glass.

The unique right angled bracket item 10 is capable of being manufactured in a range of method including but not limited to drop forging, cold forging, metal pressing, and loss-wax or investment casting processes.

The unique right angled bracket item 10 is also capable of being supplied in the range of materials disclosed and also being covered in materials to prevent corrosion and erosion wear and tear with coatings including but not limited to plastics, glass reinforced plastic and fiber glass.

In a further embodiment of the instant invention, a metallic backing plate 30 is provided secured to a flat surface by COTS fasteners, and thereby enabling the unique bracket item 10 in metallic material to be fastened thereto by magnetic action.

The unique elastic cord item 26 is capable of being manufactured in a range of methods including but not limited to elastic cord core item 32 with a series of covering materials item 34 in the form of plastic, PVC, fiber glass or equal smooth corrosion resistant materials and providing for different color configurations.

The unique elastic retaining cord item 26 as disclosed is capable of resisting loads up to 30 pounds force with an extension/elongation not exceeding 3 inches.

The overall length of the elastic retaining cord item 26 is non-limiting and is application dependent. For example, a domestic refrigerator application an overall length of between 1.5 and 2.0 foot would be appropriate, whereas for a larger setting of a recreation vehicle kitchen area, a length of between 2.0 and 3.0 foot would be practical.

In a further embodiment of the instant invention the means of attaching the brackets 10 to a flat surface is by means of a secured metallic back-plate to the flat surface by means of COTS fasteners, and providing magnetized bracket 10 for attachment thereto the back-plate.

In a further embodiment of the instant invention the means for attaching the elastic retaining cord 26 can be by means of heavy duty plastic or equal material suction cups by adhesive to the brackets 10 in for example to a smooth flat surface such as the inside of a refrigerator door.

The invention disclosed in the range of embodiments herein all provide a readily attachable and removable apparatus in kit form that can be readily be applied to a multitude of configurations.

The invention provides the user with the means for securing and retaining a variety of objects of cylindrical and irregular shapes.

The invention provides unique and novel free standing applications readily adaptable in a plurality of configurations.

The instant invention operates by employing the principles of elastic force applied to a range of cylindrical and other objects against a range of surfaces.

The instant invention meets the following user needs and requirements:
1. Can function as a daily storage for household, recreation and utility items of cylindrical and odd shapes.
2. Provides a safe product that is child/user friendly as it has no sharp edges.
3. Has a design that is intrinsically simple and minimalist in concept.
4. Provides for a product that provides with a customized coating that is both functional and visually attractive.
5. Provides for interchangeability of the major components of bracket and elastic cord, bands.
6. Accomplishes an apparatus that secures and retains a plurality of shaped products in a static state.
7. Provides for the capability to be used in a variety of settings including bicycle, sport boats and recreational vehicles.
8. Provides the ability to retain a variety of shaped objects taught and the retaining cord, band stays strong and functional over an extended period of operation.
9. Provides for a bracket and retaining cord, band configuration that cover different cord lengths.
10. Provides for an overall storage system that does not require adhesive attachment means.
11. Provides for the safe and secure storage of objects such as, baby sippy cups, all manner of bottles, and sports items such as sneakers, sports shoes, workshop tools. etc.

The application of the invention can easily described in the following discrete operational steps:
1. needs to be able to function as a daily storage use item, which means the elastic elastic band, cord, item 26 and retaining brackets item 10 are interchangeable.
2. needs to be a safe product with no sharp edges that would harm children or adults.
3. needs to be minimalist and simple design.
4. needs to have a coating and finish to prevent scratching, .abuse, moisture and wipe able.
5. needs to have interchangeable brackets, such as unique 10.

It will be evident that the instant invention has a plurality of applications for storing, retaining and providing easy access for cylindrical and odd shaped objects in a variety practical applications in a number of settings as enumerated in the following;
1. The unique storage system 28 is capable for storage of items on flat surfaces in refrigerating units in homes, offices, and in recreational applications including but not limited to boast, yachts, RV's, trucks, aircrafts, and automobiles.
2. The unique storage system 28 is capable of being used for storing workshop tools, wine bottles, baby bottles, and other cylindrical and odd shaped objects.
3. The unique storage system 28 is capable of utilization in commercial store settings for displaying sale items such as shoes, athletic sneakers, and a range of liquid containers including but not limited to sun tan spray bottles/containers, cosmetic spray bottles/containers, candy and snack items in cylindrical containers.

It will further be understood from the foregoing description that various modifications and changes can be incorporated based on the specification description and the accompanying drawings are intended for the purposes of illustration only and should not be construed in a limiting sense.

I claim:

1. An apparatus in the form of a plurality of novel right angled securing brackets with novel configurations and a unique and novel elastic retaining cord that are used in conjunction with a kit of COTS components to hold cylindrical and odd shaped objects on flat surfaces of in storage receptacle, cabinets, and other storage settings comprising:
a) unique and novel securing brackets for securing to flat surfaces, and:
b) unique and novel elastic retaining band, and cords, are in a variety of lengths and sizes, with a range weight loading capabilities and extension and stretch limits, and,
c) a kit of COTS items used in conjunction with the unique bracket and unique elastic cord.

2-The apparatus of claim 1 wherein the securing brackets comprises a unique configuration of angular slots with circular openings.

3-The apparatus of claim 1 wherein the retaining elastic cord, band is capable of withstanding a load force of 30 pounds and with an elastic extension not exceeding three inches.

4-The apparatus of claim 3 wherein the elastic retaining cord, band is in the form of a continuous loop.

5-The apparatus of claim 3 wherein the retaining elastic cord, band is in the form of two parallel and opposing bands, cords.

6-The apparatus of claim 1 wherein the securing brackets are made from metallic materials in the form of but not limited, to ferrous iron, brass, bronze, aluminum, and other non-ferrous materials.

7-The apparatus of claim 1 wherein the securing brackets are made from non metallic materials in the form of but not limited to plastics, glass-reinforced plastic, fiber glass.

8-The apparatus according to claims 6 wherein the metallic securing brackets are covered in protective materials to prevent wear and tear in the form of but not limited to, protective paint, dipped paint, plastic, glass reinforced plastic, and fiber glass.

9-The apparatus according to claim 6 wherein the non-metallic securing brackets are covered in protective materials to prevent wear and tear in the form of but not limited to, protective paint, dipped paint, plastic, glass reinforced plastic, and fiber glass.

10-The apparatus according to claim 3 wherein the retaining elastic cord, band is provided with covering materials in a variety of color renderings.

11-The apparatus according to claim 7 wherein the non-metallic brackets are attached to heavy duty plastic or equal material suction cups.

12-A method of securing and holding cylindrical and odd shaped objects, comprising the steps of;
(a) fixing at least two novel and unique brackets to a flat surface by means of COTS fasteners;
(b) attaching novel continuous loop in the form of elastic band, cord to customized slots in the brackets to form a retaining loop for a variety of odd shaped objects;
(c) placing odd shaped objects in the elastic cord, band loop for retention.

13-The method according to claim 12 wherein the elastic cord, loop is in the form of two parallel and opposing bands.

14-The method according to claim 12 wherein the means of attachment of the brackets is in the form of a metallic backing plate and magnetized metallic brackets.

15-A system for retaining cylindrical and odd-shaped objects comprising:
(a) a plurality of novel metallic brackets fastened to a flat surface using COTS type fasteners; and,
(b) a novel flexible, elastic cord or band continuous loop suspended between the metallic brackets providing the means to fix and secure cylindrical and odd shaped objects between the loops.

16-The system according to claim 15 wherein the novel brackets are made from non-metallic materials.

17-The system according to claims 15 wherein the flexible, elastic loop is formed by two separate loops.

18-The system according to claim 15 wherein the metallic brackets are magnetized and attached to a flat surface in the form of a metallic plate.
